(19) United States
(12) Patent Application Publication
(10) Pub. No.: US 2021/0158845 A1
(43) Pub. Date: May 27, 2021

(54) AUTOMATICALLY SEGMENTING AND INDEXING A VIDEO USING MACHINE LEARNING

(71) Applicant: Dell Products L. P., Round Rock, TX (US)

(72) Inventors: Parminder Singh Sethi, Ludhiana (IN); Sathish Kumar Bikumala, Round Rock, TX (US)

(21) Appl. No.: 16/693,584

(22) Filed: Nov. 25, 2019

(51) Int. Cl. G11B 27/34; G06K 9/62; G06K 9/00; G10L 15/22; G10L 15/18; G11B 27/10

(52) U.S. Cl. CPC G11B 27/34; G06K 9/6256; G06K 9/00765; G10L 25/90; G10L 15/1815; G11B 27/102; G06K 2209/01; G10L 15/22

(57) ABSTRACT

In some examples, a server retrieves a video and performs an audio analysis of an audio portion of the video and a video analysis of a video portion of the video. The video may provide information on modifying a hardware configuration and/or a software configuration of a computing device. The audio analysis performs natural language processing to the audio portion to determine a set of words indicative of a start and/or end of a segment. The video analysis uses a convolutional neural network to analyze the video portion to determine frames in the video portion indicative of a start and/or end of a segment. Machine learning segments the video by adding chapter markers based on the video analysis and the audio analysis. The video is indexed, hyperlinks are associated with each segment, and each hyperlink named to enable a user to select and stream a particular segment.

### BACKGROUND OF THE INVENTION

### Field of the Invention

This invention relates generally to segmenting and indexing a video and, more particularly to using machine learning to automatically (e.g., without human interaction) identify different segments in a video to segment (e.g., adding chapter markers) and index the video.

### Description of the Related Art

As the value and use of information continues to increase, individuals and businesses seek additional ways to process and store information. One option available to users is information handling systems (IHS). An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Many computing device manufacturers and resellers provide videos on their websites that explain how to modify software associated with a computing device, how to modify hardware associated with a computing device, and the like. Computing devices (laptop computers, desktop computers, and the like) may use a modular assembly such several components are removed before accessing a particular component. For example, to modify a particular component, such as, for example, an amount of random-access memory (RAM), a storage drive, a communications card, or the like, the video may explain how to remove other components to access the particular component. To illustrate, to replace a storage drive in a laptop, the video may illustrate removing the back cover, removing the battery, and removing a keyboard to access the storage drive's location. However, the video may not have chapter markers (or the like), forcing a user who is already familiar with removing the back cover and the battery to view the process of removing the back cover and the battery before arriving at the user's topic of interest (e.g., removing the keyboard to access the storage drive).

### SUMMARY OF THE INVENTION

This Summary provides a simplified form of concepts that are further described below in the Detailed Description. This Summary is not intended to identify key or essential features and should therefore not be used for determining or limiting the scope of the claimed subject matter.

In some examples, a server retrieves a video and performs an audio analysis of an audio portion of the video and a video analysis of a video portion of the video. The video may provide information on modifying a hardware configuration and/or a software configuration of a computing device. The audio analysis performs natural language processing to the audio portion to determine a set of words indicative of a start and/or end of a segment. The video analysis uses a convolutional neural network to analyze the video portion to determine frames in the video portion indicative of a start and/or end of a segment. Machine learning segments the video by adding chapter markers based on the video analysis and the audio analysis. The video is indexed, hyperlinks are associated with each segment, and each hyperlink labeled with a name to enable a user to select and stream a particular segment.

### BRIEF DESCRIPTION OF THE DRAWINGS

A more complete understanding of the present disclosure may be obtained by reference to the following Detailed Description when taken in conjunction with the accompanying Drawings. In the figures, the left-most digit(s) of a reference number identifies the figure in which the reference number first appears. The same reference numbers in different figures indicate similar or identical items.

FIG. 1 is a block diagram of a system that includes a server that uses machine learning to segment a video into multiple segments, according to some embodiments.

FIG. 2 is a block diagram of a system that includes an audio analyzer and a video analyzer, according to some embodiments.

FIG. 3 is a block diagram of a system that includes a frame analyzer, according to some embodiments.

FIG. 4 is a block diagram illustrating determining sentiments in a video, according to some embodiments.

FIG. 5 is a block diagram illustrating training a classifier to create a machine learning algorithm to segment a video, according to some embodiments.

FIG. 6 is a block diagram of system that includes streaming a segment of a video, according to some embodiments.

FIG. 7 is a flowchart of a process that uses machine learning to determine segments in a video, according to some embodiments.

FIG. 8 illustrates an example configuration of a computing device that can be used to implement the systems and techniques described herein.

### DETAILED DESCRIPTION

For purposes of this disclosure, an information handling system (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or video display. The information handling system may also include one or more buses operable to transmit communications between the various hardware components.

The systems and techniques described herein may be used to automatically segment and index videos, such as, for example, training videos that describe how to modify components of a computing device by (i) removing an existing component and replacing the existing component with a replacement component or (ii) adding a new component. For example, machine learning (e.g., a machine learning algorithm), such as a classifier (e.g., support vector machine or the like), may be used to automatically determine where a change in topic occurs in the video and place a chapter marker where the change in topic occurs to segment the video. The machine learning may automatically create an index that includes links to each chapter marker to enable each topic in the video to be accessed using a hyperlink.

The audio portion of the video may be extracted to create an audio file and the video portion of the video may be extracted to create a video file. The audio file may be analyzed using natural language processing (NLP) that includes analyzing the words and phrases in the audio file as well as the inflection and pitch of a user's voice. The NLP analysis may be used to determine where a change in topic is occurring. Speech-to-text analysis may be used to create a text file based on the audio file. A text analyzer may analyze the text file to determine where a change in topic is occurring. For example, if the audio includes “after removing the back cover, we are now going to remove the laptop battery” then the NLP, the text analyzer, or both may search for words such as “after”, “now”, “remove” and the like to determine whether a change in topic is occurring. The NLP, the text analyzer, or both may search for pauses greater than a predetermined length (e.g., 15, 30, 45 seconds or the like) to determine whether a change in topic is occurring. The NLP analysis may be correlated with the text analysis to reduce false positives.

The video file may be analyzed using one or more techniques. For example, optical character recognition (OCR) may be used on individual video frames to create a text file and a text analyzer used to determine where a change in topic is occurring. To illustrate, the creator of the video may have text superimposed on the video data to indicate a particular topic, e.g., removing the back cover”, “removing the battery”, “replacing the storage drive”, “replacing the memory”, “replacing the communications card”, “removing the keyboard” and the like. The text analyzer may search the text file created using OCR of the video frames to identify particular words that are indicative of the start (or end) of a particular topic. For example, the text analyzer may search for “remov*”, where “*” is a wild card operator, to identify words such as “removing”, “remove”, “removal” and the like. A frame analyzer may analyze consecutive frames to determine when the content in a frame is significantly different from the content in a subsequent frame, indicating the possibility that a change in topic has occurred. For example, frames illustrating removing multiple screws of a back cover may include a screwdriver. The absence of the screwdriver in a subsequent frame (or a subsequent set of frames) may indicate that a screw removal portion of the video has been completed and a new topic (e.g., removing the back cover) is starting. The frame analyzer may look for a dissolve used by the creator of the video to transition from one segment to another segment. In a video, a dissolve overlaps two shots or scenes and transitions from a segment to a subsequent segment. The dissolve gradually (e.g., usually 500 milliseconds (ms) or greater) transitions from an image of one segment to another image of a subsequent segment. The dissolve overlaps two shots for the duration of the effect, usually at the end of one segment and the beginning of the next segment. The video analysis may include using convolutional neural networks and image classification to determine when a change in topic is occurring.

The video analysis may include analyzing facial expressions of a presenter in the video to determine micro-expressions and using the micro-expressions to determine when a change in topic occurs in the video. For example, each micro-expression may be determined to indicate a particular sentiment, such as neutral, surprise, fear, disgust, anger, happiness, sadness, and contempt. The neutral micro-expression may include eyes and eyebrows neutral and the mouth opened or closed with few wrinkles. The surprise micro-expression may include raised eyebrows, stretched skin below the brow, horizontal wrinkles across the forehead, open eyelids, whites of the eye (both above and below the eye) showing, jaw open and teeth parted, or any combination thereof. The fear micro-expression may include one or more eyebrows that are raised and drawn together (often in a flat line), wrinkles in the forehead between (but not across) the eyebrows, raised upper eyelid, tense (e.g., drawn up) lower eyelid, upper (but not lower) whites of eyes showing, mouth open, lips slightly tensed or stretched and drawn back, or any combination thereof. The disgust micro-expression may include a raised upper eyelid, raised lower lip, wrinkled nose, raised cheeks, lines below the lower eyelid, or any combination thereof. The anger micro-expression may include eyebrows that are lowered and drawn together, vertical lines between the eyebrows, tense lower eyelid(s), eyes staring or bulging, lips pressed firmly together (with corners down or in a square shape), nostrils flared (e.g., dilated), lower jaw jutting out, or any combination thereof. The happiness micro-expression may include the corners of the lips drawn back and up, the mouth may be parted with teeth exposed, a wrinkle may run from the outer nose to the outer lip, cheeks may be raised, lower eyelid may show wrinkles, Crow's feet near the eyes, or any combination thereof. The sadness micro-expression may include the inner corners of the eyebrows drawn in and up, triangulated skin below the eyebrows, one or both corners of the lips drawn down, jaw up, lower lip pouts out, or any combination thereof. The contempt (e.g., hate) micro-expression may include one side of the mouth raised. A change in micro-expression may signal a change in topic. For example, the presenter in the video may display a first micro-expression (e.g., fear, disgust, sadness or the like) when concentrating to remove a component (e.g., of a computing device) or add a component and display a second micro-expression (e.g., happiness) after the presenter has completed the removal or addition of the component.

Machine learning may use the information from analyzing the audio portion (e.g., NLP analysis and text analysis) and the video portion (frame analysis and OCR text analysis) to determine (e.g., predict) when a change in topic is occurring and place a chapter marker at a location in the video where the machine learning predicts a new topic is beginning. The multiple analysis may be correlated with some sources of information being given more weight than other sources of information. For example, a dissolve may have a highest weighting, text information derived from performing an OCR of the frames may be given a second highest weighting, frame analysis may be given a third highest weighting, and so on.

The segmented video may be made available for viewing (e.g., streaming) on a site. The site may include an index to the video. The index may provide a text-based word or phrase indicating a topic (e.g., “back cover removal”, “disk drive replacement” or the like) and a link to the chapter marker corresponding to the start of the video segment that discusses the topic. A user may select the link to initiate playback of the video at the beginning of the selected topic. Those viewing the video may be given permission to post comments. For example, the machine learning may place a chapter marker at a time T=12:24 (e.g., 12 minutes and 24 seconds from the start of the video) and the user comments may indicate that (i) the chapter marker is too early (e.g., chapter marker should be later, e.g., at T=12:34), (ii) the chapter marker is too late (e.g., chapter marker should be earlier, e.g., at T=12:07), or (iii) an additional chapter marker should be added at time 14:40. The machine learning may modify the chapter markers based on the user comments. The comments may be used as input to further train the machine learning.

As an example, a computing device may include one or more processors and one or more non-transitory computer-readable storage media to store instructions executable by the one or more processors to perform various operation. For example, the operations may include retrieving (or receiving) a video, extracting an audio portion of the video to create an audio file, and extracting a video portion of the video to create a video file. The operations may include analyzing the audio file to create an audio analysis. For example, analyzing the audio file to create the audio analysis may include performing natural language processing to identify, in the audio file, a set of one or more words indicative of the start of a segment, and indicating in the audio analysis, a time from a start of the video where the set of one or more words were spoken. As another example, analyzing the audio file to create the audio analysis may include performing text-to-speech analysis of contents of the audio file to create a first text file, performing natural language processing to identify, in the first text file, a set of one or more words indicative of the start of a segment, and indicating in the audio analysis, a time from a start of the video where the set of one or more words are located. The operations may include analyzing the video file to create a video analysis. For example, analyzing the video file to create the video analysis may include determining, using a micro-expression analyzer, one or more micro-expressions of a presenter in the video, determining a sentiment corresponding to the micro-expression (e.g., the sentiment may be either happy or unhappy), and indicating in the video analysis, a time of a start of the micro-expression and the corresponding sentiment. As another example, analyzing the video file to create the video analysis may include performing, using a convolutional neural network, a frame analysis of the video file, determining, using the frame analysis, a time of a start of at least one segment in the video file, and indicating in the video analysis, the time of the start of at least one segment in the video file. As a further example, analyzing the video file to create the video analysis may include performing optical character recognition of one or more frames of the video to create a second text file, performing natural language processing to identify, in the second text file, a set of one or more words indicative of the start of a segment, and indicating in the video analysis, a time from a start of the video where the set of one or more words are located. The operations may include determining, by a machine learning algorithm, one or segments in the video based on the audio analysis and the video analysis. The operations may include adding one or more chapter markers to the video to create a segmented video. For example, individual chapter markers of the one or more chapter markers may correspond to a starting position of individual segments of the one or more segments. The operations may include associating a hyperlink of one or more hyperlinks with individual chapter markers of the one or more chapter markers. The operations may include creating an index that includes the one or more hyperlinks, and providing access to the index via a network. The operations may include receiving from a computing device, via the network, a command selecting a particular hyperlink of the one or more hyperlinks, determining a particular segment of the one or more segments corresponding to the particular hyperlink, and initiating streaming the particular segment, via the network, to the computing device. The operations may include receiving from the computing device, via the network, a second command selecting a second particular hyperlink of the one or more hyperlinks, determining a second particular segment of the one or more segments corresponding to the second particular hyperlink, and initiating streaming of the second particular segment, via the network, to the computing device.

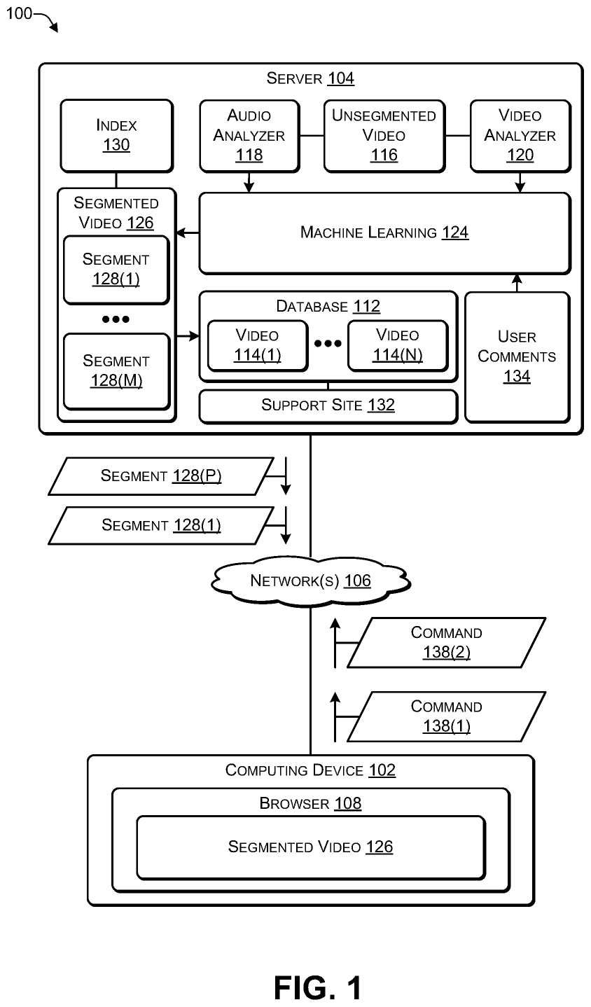

FIG. 1 is a block diagram of a system 100 that includes a server that uses machine learning to segment a video into multiple segments, according to some embodiments. The system 100 includes a representative computing device 102 connected to a server 104 via one or more networks 106. The computing device 102 may include a browser application 108.

The server 104 may include a database 112 that includes multiple segmented videos, such as a video 114(1) to a video 114(N) (N>0). The server 104 may select an unsegmented video 116. The server 104 may use an audio analyzer 118 (e.g., an audio machine learning algorithm) to perform in an analysis of an audio portion of the unsegmented video 116 and use a video analyzer 120 (e.g., a video machine learning algorithm) to perform an analysis of a video portion of the unsegmented video 116. The results of performing the analysis may be provided to machine learning 124 (e.g., a machine learning algorithm). The machine learning 124 may use the results of the audio analyzer 118 and the video analyzer 120 to create a segmented video 126 that corresponds to the unsegmented video 116. The segmented video 126 may include multiple segments such as, for example, a segment 128(1) to a segment 128(M). The machine learning 124 may create an index 130 associated with the segmented video 126. For example, the index 130 may have an associated segment name and an associated hyperlink. The associated hyperlink may provide access to a beginning of each segment (e.g., each chapter) in the segmented video 126. Thus, if the user is interested in a particular topic, the user can review the segment names, identify a particular segment name associated with the particular topic, and select the associated hyperlink to directly access (e.g., playback) a particular segment of the segmented video 126. For example, if the segment 128(M) is selected, the segment 128(M) may be played back by streaming a portion of the segmented video 126 from the server 104, over the network 106, to the computing device 102 and displayed in the browser 108. The segmented video 126 may use a standard such as, for example, motion picture experts group (MPEG) (e.g., MPEG-2, MPEG-4, or the like), Adobe® Flash Video Format (FLV), Audio Video Interleave (AVI), Windows® Media Video (WMV), Apple® QuickTime Movie (MOV), Advanced Video Coding High Definition (AVCHD), Matroska (MKV), or the like. The Matroska Multimedia Container (MKV) is an open-standard container format that can hold an unlimited number of video files, audio files, pictures, or subtitle tracks in a single file.

When a user of the computing device 102 desires to perform a software operation (e.g., configuring a particular software component) or a hardware operation (e.g., adding, removing, or replacing a particular hardware component) to a computing device, the user may navigate the browser 108 to a support site 132. The user may browse the videos 114 in the database 112 (e.g., accessible via the support site 132) and select the segment 128(1) of the segmented video 126. The server 104 may stream the segmented 128(1) via the network 106 to the computing device 102. The user may send a command 138(1) to instruct the server 104 to playback a segment 128(X) (1<X<M), causing the server 104 to begin streaming the segment 128(X) to the computing device 102 via the network 106. The user may send a command 138(2) to instruct the server 104 to playback a second segment 128(Y) (1<Y<M, X not equal to Y), causing the server 104 to begin streaming the second segment 128(Y) to the computing device 102 via the network 106

The support site 132 may enable the user of the computing device 102 to provide user comments 134 in a user comments section of the site. For example, the user comments 134 may suggest that a particular segment of the segments 128 start sooner or later that a current start time of the particular segment. The user comments 134 may suggest that a new segment be added at a particular time to the segmented video 126. To illustrate, the user comments 134 may suggest that the segment 128(M), which currently starts at a time T1, be adjusted to start at a time T2, where T1<T2 (e.g., start later) or T1>T2 (start earlier). The user comments 134 may be used as input to further train the machine learning 124 to improve an accuracy of the machine learning 124.

Thus, a server may perform an analysis of an unsegmented video. The analysis may include analyzing a video portion of the video and an audio portion of the video. The analysis may be used by a machine learning algorithm to automatically segment the video to create a segmented video. The machine learning may use the analysis to automatically label each segment with a name (e.g., a word or a phrase describing the segment) and associate a hyperlink with each name. A user may browse the names of the segments to identify a topic of interest to the user and select the associated hyperlink to initiate playback of a particular segment. For example, selecting a hyperlink associated with the name “disk drive” or “replace disk drive” may cause playback of a segment that shows a user how to access a particular location in a computing device to replace the disk drive.

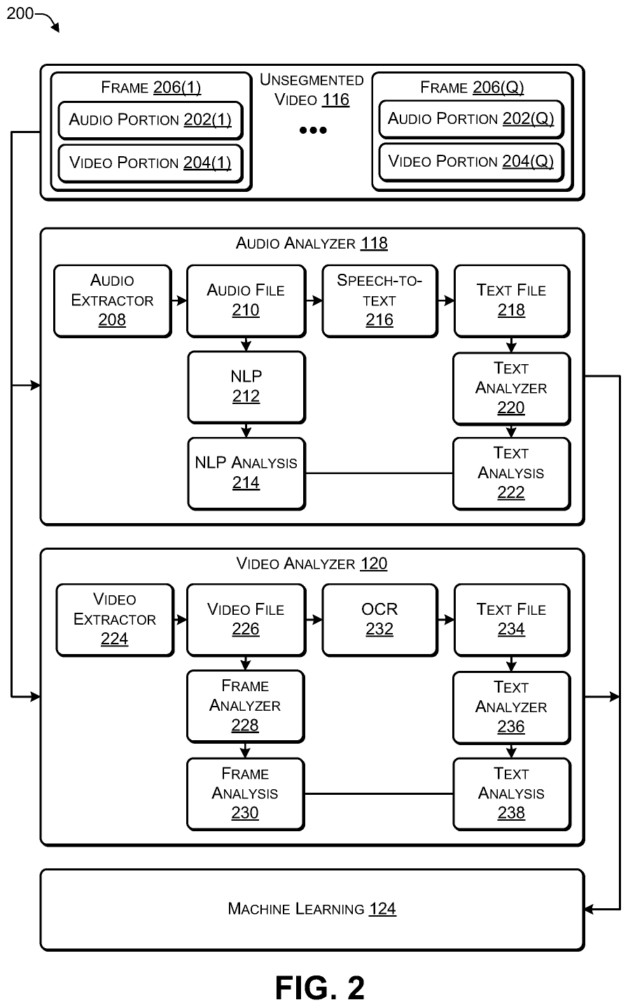

FIG. 2 is a block diagram of a system 200 that includes an audio analyzer and a video analyzer, according to some embodiments. The system 200 illustrates how the audio analyzer 118 and the video analyzer 120 may analyze the unsegmented video 116 and provide the machine learning 124 with analysis information to enable the machine learning 124 two segment the unsegmented video 116.

The unsegmented video 116 may include multiple frames, such as a frame 206(1) to a frame 206(Q). Each of the frames 206 may include an audio portion and a video portion. For example, the frame 206(1) may include an audio portion 202(1) and a video portion 204(1) and the frame 206(Q) may include an audio portion 202(Q) and a video portion 204(Q), where Q is greater than zero.

The audio analyzer 118 may use an audio extractor module 208 to extract an audio file 210 from the audio portions 202 of the unsegmented video 116. The audio analyzer 118 may use natural language processing (NLP) 212 to analyze the audio file 210 to create a natural language processing analysis 214. The NLP 112 may identify particular words or phrases that are indicative of a beginning of a new segment, such as, for example, now, next, after, before, remove, insert, add, replace, and the like. The NLP 112 may perform a pitch analysis of a presenter's voice in the audio file 210. For example, the presenter's voice may change in pitch (e.g., higher or lower in pitch as compared to other portions of the video 116) when a particular segment is beginning or ending. The audio analyzer 118 may use a speech-to-text module 216 to convert speech included in the audio file 210 into text, thereby creating a text file 218. A text analyzer module 220 may analyze the text file 218 to create text analysis 222. For example, the text analyzer 220 may identify particular words or phrases that are indicative of a beginning of a new segment, such as, for example, next, after, before, remove, insert, add, replace, and the like. The audio analyzer 118 may provide the NLP analysis 214 and the text analysis 222 to the machine learning 124 to enable the machine learning 124 to determine when a segment begins, when a segment ends, or both.

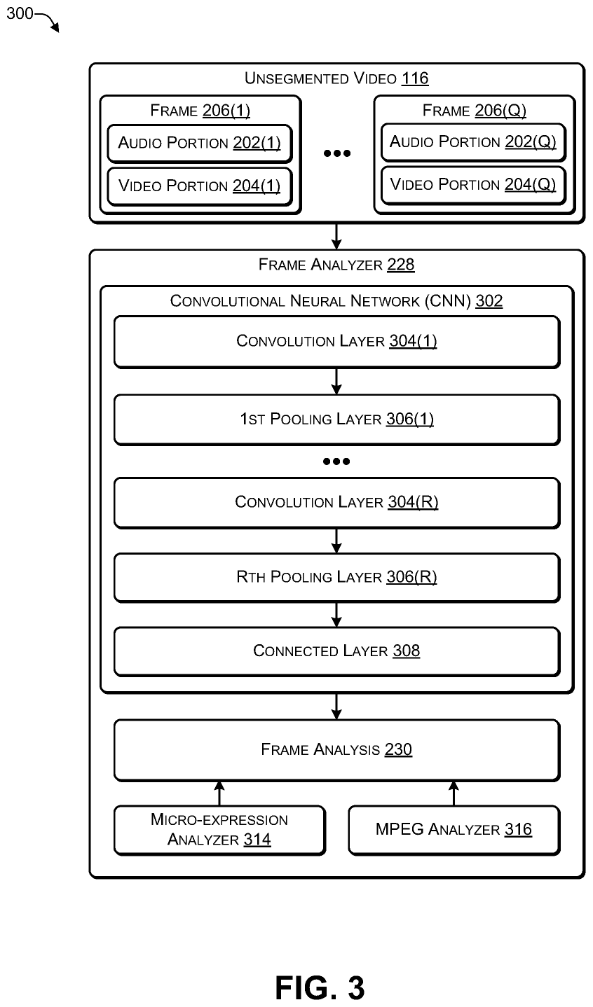

The video analyzer 120 may use a video extractor 224 to extract the video portion 204 of the unsegmented video 116 to create a video file 226. The video analyzer 120 may use a frame analyzer 228 to analyze the frames in the video file 226 to create a frame analysis 230. The frame analysis 230 is described in more detail in FIG. 3. The video analyzer 120 may use optical character recognition (OCR) 232 to recognize text displayed in one or more of the frames 206 to create a text file 234. For example, the video file 226 may display text-based information in the video portions 204 of the video 116. The video analyzer 120 may use a text analyzer 236 to analyze the text file 234 to create a text analysis 238. The video analyzer 120 may provide the frame analysis 230 and the text analysis 238 to the machine learning 124 to enable the machine learning 124 to determine when a segment begins, when a segment ends, or both.

The machine learning 124 may use the NLP analysis 214, the first text analysis 222, the frame analysis 230, and the second text analysis 238 to identify segments in the unsegmented video 116 and place chapter markers at the beginning of each segment to create a segmented video. In some cases, the machine learning 124 may correlate the NLP analysis 214, the first text analysis 222, the frame analysis 230, and the second text analysis 238 to identify segments. For example, each of the NLP analysis 214, the first text analysis 222, the frame analysis 230, and the second text analysis 238 may be given a particular weight:

(W1×NLP analysis 214)+(W2×1st text analysis 222)+(W3×frame analysis 230)+(W4×second text analysis 238)=P1 (Probability Score)

where P1 represents the probability that a segment starts at a particular time T1. When two or more of the NLP analysis 214, the first text analysis 222, the frame analysis 230, and the second text analysis 238 indicate that a segment appears to have started at time T1, then P1 may be calculated using the above formula. If P1 satisfies a particular threshold, then there is a greater probability that a segment starts at time T1 and a chapter marker may be added. If P1 does not satisfy the particular threshold, then there is a lesser probability that a segment starts at time T1, and a chapter marker may not be added.

Thus, a video file may be created using a video portion of a video and an audio file may be created using an audio portion of the video. An audio analyzer may analyze the audio file (e.g., using NLP) to identify audio events indicative of a beginning of a segment (e.g., a particular topic or sub-topic). For example, the audio analyzer may look for words such as “now”, “after”, “before” “here”, “next” or the like. A video analyzer may analyze the video file to identify video events indicative of a beginning of a segment (e.g., a particular topic or sub-topic). For example, the video analyzer may use convolution neural networks, micro-expression analysis, mpeg analysis, and other techniques to identify when a segment is beginning.

FIG. 3 is a block diagram of a system 300 that includes a frame analyzer, according to some embodiments. The frame analyzer 228 may use deep learning, such as a convolutional neural network (CNN) 302 to analyze the unsegmented video 116.

The CNN 302 is a neural network that use convolution in place of general matrix multiplication in at least one layer. The CNN 302 includes an input layer (e.g., the video 116) and an output layer (e.g., the frame analysis 230), as well as multiple inner layers. The inner layers of the CNN 302 may include a series of convolutional layers, such as a convolution layer 304(1) to a convolution layer 304(R) (where R>0), that convolve using multiplication (or another dot product). Individual layers of the convolution layers 304 may be followed by additional convolution layers, known as pooling layers, such as pooling layer 306(1) that follows the convolutional layer 304(1) to a pooling layer 306(R) that follows the convolutional layer 304(R). Though the layers 304 are referred to as convolutions, from a mathematical perspective, each of the layers 304 is a sliding dot product or cross-correlation. When programming the CNN 302, each convolutional layer 304 uses as input a tensor with shape (number of images)×(image width)×(image height)×(image depth). Convolutional kernels whose width and height are hyper-parameters, and whose depth must be equal to that of the image. Each of the convolutional layers 304 convolve the input (e.g., the video 116) and pass a result to the next layer. For example, regardless of image size, tiling regions of size 5×5, each with the same shared weights, may use only 25 learnable parameters. The CNN 302 may include pooling layers 306 to streamline underlying computations. The pooling layers 306 may reduce the dimensions of the data by combining the outputs of neuron clusters at one layer into a single neuron in the next layer. The pooling layers 306 may local pooling, global pooling, or both. Local pooling combines small clusters, typically 2×2. Global pooling acts on all the neurons of the convolutional layer. In the CNN 302, each neuron receives input from some number of locations in the previous layer. In a fully connected layer, each neuron receives input from every element of the previous layer. In a convolutional layer, neurons receive input from only a restricted subarea of the previous layer, usually the subarea is of a square shape (e.g., size 5 by 5). The input area of a neuron is called its receptive field. Thus, in a fully connected layer, the receptive field is the entire previous layer. In a convolutional layer, the receptive area is smaller than the entire previous layer. Each neuron in the CNN 302 computes an output value by applying a specific function to the input values coming from the receptive field in the previous layer. The function that is applied to the input values is determined by a vector of weights and a bias (typically real numbers). Learning, in the CNN 302, progresses by making iterative adjustments to these biases and weights. The vector of weights and the bias are called filters and represent particular features of the input (e.g., a particular shape). In the CNN 302, many neurons may share the same filter to reduce memory footprint because a single bias and a single vector of weights may be used across all receptive fields sharing that filter, as opposed to each receptive field having its own bias and vector weighting.

For each convolution layer 304, each frame 206 (represented as a matrix with pixel values) is used as input. The input matrix is read starting at the top left of image. The CNN 302 may then select a smaller matrix, called a filter (or neuron). The filter produces convolution, i.e. moves along the input frame. The filter multiplies the convolution values with the original pixel values and then sums up the multiplications to obtain a single number. The filter reads the image starting in the upper left corner and repeatedly moves further right (by 1 unit), performing a similar operation. After passing the filter across all positions of the input frame, a matrix is obtained, but smaller than the input matrix. Each of the pooling layers 306 follow one of the convolution layers 304. The pooling layers 306 work with a width and a height of each of the frames 206 to perform a down sampling operation to reduce a size of the image. Thus, features (e.g., boundaries) that have been identified by a previous convolution layer 304 are not identified, enabling a detailed frame to be compressed to a less detailed frame. A connected layer 308 may be added to the output from the previous layers 304, 306. Attaching the fully connected layer 308 to the end of the results of the layers 304, 306 may result in an N dimensional vector, where N is the amount of classes from which the model selects the desired class. An input frame will be passed to the vary first convolutional layer. Which will return activation map as an output. Relevant features/context will be extracted using the filters in the convolution layer from each frame to frame and same will be passed further.

Each of the convolution layers 304 bring a different perspective in the class/context prediction. Each of the pooling layers 306 reduce the number of parameters. The convolution layers 304 and multiple pooling layers 306 have been added before the output is made. Convolutional layers 304 may extract context while the pooling layers 306 merging the common context and reduce the repeating context in different frames.

In some cases, the frame analyzer 228 may include a micro-expression analyzer 314 to analyze a presenter's expression in each of the frames 206 of the unsegmented video 116. For example, each micro-expression may be determined to indicate a particular sentiment, such as neutral, surprise, fear, disgust, anger, happiness, sadness, and contempt. The neutral micro-expression may include eyes and eyebrows neutral and the mouth opened or closed with few wrinkles. The surprise micro-expression may include raised eyebrows, stretched skin below the brow, horizontal wrinkles across the forehead, open eyelids, whites of the eye (both above and below the eye) showing, jaw open and teeth parted, or any combination thereof. The fear micro-expression may include one or more eyebrows that are raised and drawn together (often in a flat line), wrinkles in the forehead between (but not across) the eyebrows, raised upper eyelid, tense (e.g., drawn up) lower eyelid, upper (but not lower) whites of eyes showing, mouth open, lips slightly tensed or stretched and drawn back, or any combination thereof. The disgust micro-expression may include a raised upper eyelid, raised lower lip, wrinkled nose, raised cheeks, lines below the lower eyelid, or any combination thereof. The anger micro-expression may include eyebrows that are lowered and drawn together, vertical lines between the eyebrows, tense lower eyelid(s), eyes staring or bulging, lips pressed firmly together (with corners down or in a square shape), nostrils flared (e.g., dilated), lower jaw jutting out, or any combination thereof. The happiness micro-expression may include the corners of the lips drawn back and up, the mouth may be parted with teeth exposed, a wrinkle may run from the outer nose to the outer lip, cheeks may be raised, lower eyelid may show wrinkles, Crow's feet near the eyes, or any combination thereof. The sadness micro-expression may include the inner corners of the eyebrows drawn in and up, triangulated skin below the eyebrows, one or both corners of the lips drawn down, jaw up, lower lip pouts out, or any combination thereof. The contempt (e.g., hate) micro-expression may include one side of the mouth raised. A change in micro-expression may signal a change in topic.

For example, a presenter in the video 116 may display a first micro-expression (e.g., fear, disgust, sadness or the like) when concentrating to remove a component (e.g., of a computing device) or add a component, indicating the start of a segment. To illustrate, the presenter may display the first micro-expression when removing one or more screws, removing a cover that is held in place mechanically, or performing another operation in which the presenter is concentrating. The presenter in the video 116 may display a second micro-expression (e.g., happiness) after the presenter has completed the removal, addition, or replacement of a component, indicating the end of a segment.

The frame analysis 230 may include an analysis provided by an MPEG analyzer 316. For example, if the unsegmented video 116 is encoded using a standard promulgated by the Motion Pictures Experts Group (MPEG), such as MPEG-1, MPEG-2, MPEG-4, or the like, the MPEG analyzer 316 may perform an analysis of the frames 206 to identify where a significant change occurs between one frame and a subsequent frame, indicating that a previous segment had ended and a new segment has started. An MPEG encoder may make a prediction about an image and transform and encode the difference between the prediction and the image. The prediction takes into account movement within an image using motion estimation. Because a particular image's prediction may be based on future images as well as past ones, the encoder may reorder images to put reference images before predicted images.

MPEG uses three types of coded frames, an I-frame, a P-frame, and a B-frame. I-frames (intra-frames) are frames coded as individual still images. P-frames (predicted frames) are predicted from a most recently reconstructed I or P frame. Each macroblock in a P frame may either come with a vector and difference discrete cosine transform (DCT) coefficients for a close match to the last I-frame or P-frame, or may be an intra coded frame if there was no good match. B-frames (bidirectional frames) are predicted from the closest two I or P frames, one in the past and one in the future. The encoder searches for matching blocks in those frames, and tries three different things to see which works best: using the forward vector, using the backward vector, and averaging the two blocks from the future and past frames and subtracting the result from the block being coded. Thus, a typical sequence of decoded frames might be:
IBBPBBPBBPBBIBBPBBPB
   in which there are 12 frames from I to I, based on a random-access requirement that there be a starting point about every 0.4 seconds. Because the MPEG encoder encodes the difference between a predicted frame and an existing frame, the MPEG analyzer 316 may analyze the encoded difference between two frames to determine if the difference satisfies a particular threshold that indicates a previous segment is ending and a new segment is starting.

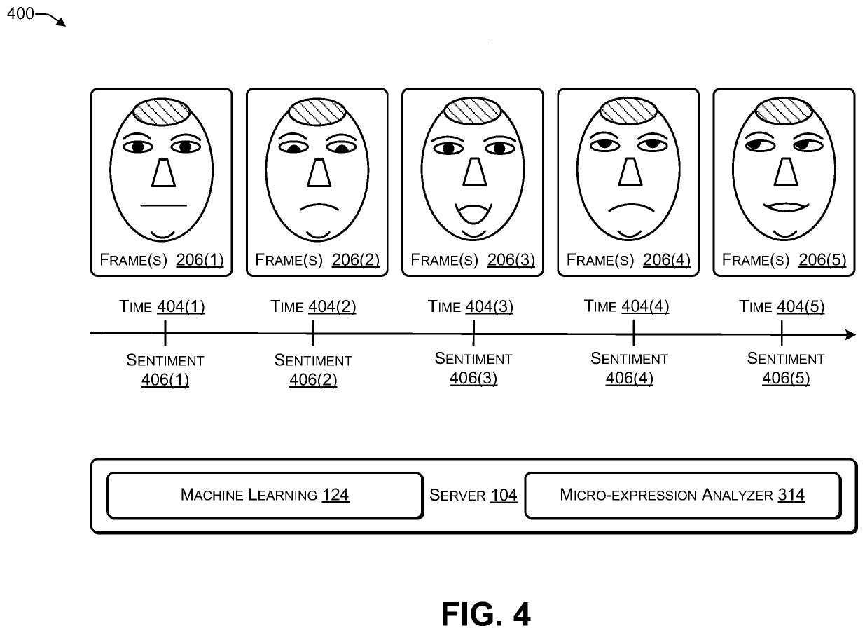

FIG. 4 is a block diagram of a system 400 in which sentiments of a presenter in a video are determined, according to some embodiments. Of course, some videos may not include a presenter's face. However, for videos in which the presenter's face is present, the systems and techniques described herein may be used to determine the presenter's sentiment. The machine learning 124 may use the sentiments as input when determining (predicting) where a segment begins and/or ends.

The machine learning module 114 may analyze a set of (e.g., one or more) frames 206(1) and determine an associated sentiment 406(1) (e.g., neutral). Based on a timestamp associated with the frames 206(1), the micro-expression analyzer 314 may determine a time 404(1) indicating when the user displayed the sentiment 406(1). For example, the micro-expression analyzer 314 may use a Society of Motion Picture and Television Engineers (SMPTE) timecode associated with each set of frames 206 to determine the associated time where a particular sentiment was displayed. The time 404(1) may indicate when the sentiment 406(1) was first displayed in the frames 206(1) or when the sentiment 406(1) was last displayed in the frames 206(1).

The machine learning module 114 may analyze a set of frames 206(2) and determine an associated sentiment 406(2) (e.g., slight unhappiness or concentration). Based on a timestamp associated with the frames 206(2), the micro-expression analyzer 314 may determine a time 404(2) indicating when the user displayed the sentiment 406(2). The sentiment 406(2) may indicate the start of a segment.

The machine learning module 114 may analyze a set of frames 206(3) and determine an associated sentiment 406(3) (e.g., happiness or success). Based on a timestamp associated with the frames 206(3), the micro-expression analyzer 314 may determine a time 404(3) indicating when the user displayed the sentiment 406(3). The sentiment 406(3) may indicate the end of a segment.

The machine learning module 114 may analyze a set of frames 206(4) and determine an associated sentiment 406(4) (e.g., unhappiness or concentration). Based on a timestamp associated with the frames 206(4), the micro-expression analyzer 314 may determine a time 404(4) indicating when the user displayed the sentiment 406(4). The sentiment 406(4) may indicate the start of a segment.

The machine learning module 114 may analyze a set of frames 206(5) and determine an associated sentiment 406(5) (e.g., neutral). Based on a timestamp associated with the frames 206(5), the micro-expression analyzer 314 may determine a time 404(5) indicating when the user displayed the sentiment 406(5).

Thus, frames of a video may be analyzed to identify a micro-expression of a user and when the user displayed the micro-expression. The micro-expressions may be used as input by machine learning to determine (predict) when a segment begins and when the segment ends.

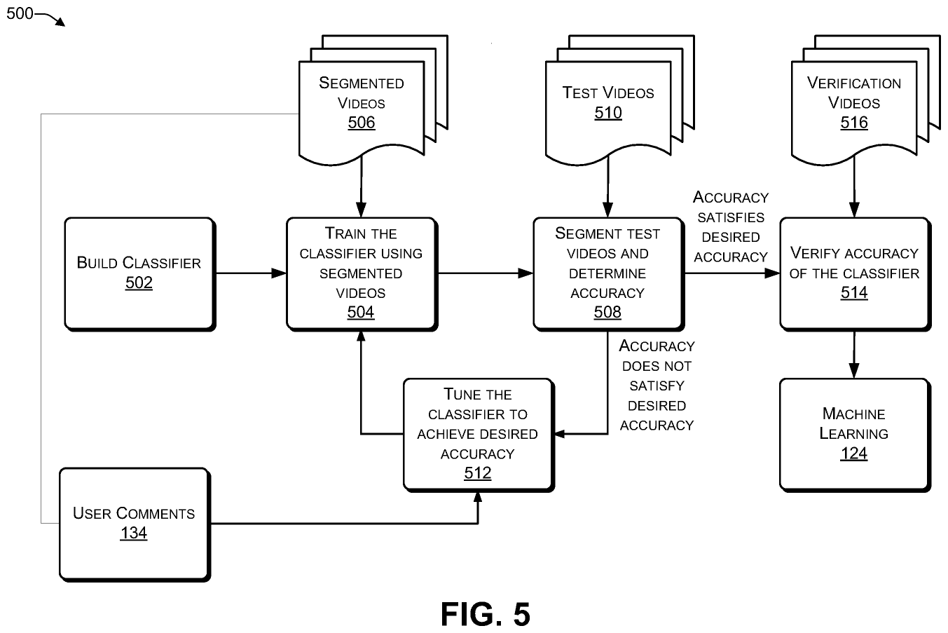

FIG. 5 is a block diagram of a system 500 to train a classifier to create machine learning to segment a video, according to some embodiments. For example, the machine learning 124 may be implemented using a support vector machine (SVM) or the like to predict when a previous segment is ending, when a new segment is starting, or both.

At 502, a classifier (e.g., classification algorithm) may be built, e.g., implemented in software. At 504, the classifier may be trained using segmented videos 506. For example, the segmented videos 506 may be segmented by human beings. At 508, the classifier may be used to create segments in unsegmented test videos 510 and an accuracy of the classifier may be determined. If the accuracy does not satisfy a desired accuracy, then the process may proceed to 512, where the software code of the classifier may be modified (e.g., tuned) to increase accuracy to achieve the desired accuracy, and the process may proceed to 504 to re-train the classifier. Thus, 504, 508, and 512 may repeated until the classifier achieves the desired accuracy.

If at 508, the classifier segments the test videos 510 with an accuracy that satisfies the desired accuracy, then the process may proceed to 514, where an accuracy of the classifier is verified using unsegmented verification videos 516 to create the machine learning 124. The classifier may be periodically re-tuned to take into account the user comments 134. For example, users may view segmented videos available on the support site 132 and provide the user comments 134. The user comments 134 may be used to further tune the classifier, at 512.

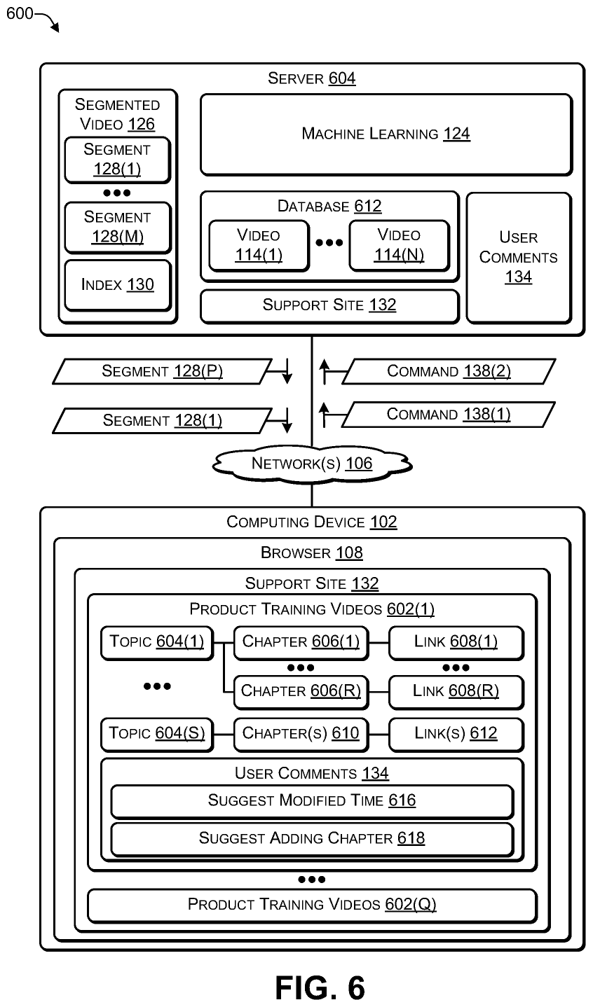

FIG. 6 is a block diagram of system 600 that includes streaming a segment of a video, according to some embodiments. The user may use the browser 1082 navigate to the support site 132 that is hosted by the server 604. The support site 132 may include multiple training videos, such as product training videos 602(1) to product training videos 602(Q) (Q>0). Each of the product training videos 602 may include information on configuring hardware components, software components or both associated with the computing device. For example, configuring a hardware component may include removing a current component and the replacing the current component with a new (replacement) component. Configuring a hardware component may include changing settings associated with the hardware component. Configuring a hardware component may include adding a component to a particular location, such as an empty slot, in a computing device. Configuring a software component may include downloading and installing new software, such as a software application or a driver, and configuring one or more parameters associated with the new software.

As illustrated in FIG. 6, the support site 132 may display multiple product training videos 602 associated with multiple products. For a particular product, the support site 132 may display multiple topics, such as a topic 604(1) to a topic 604(S) (S>0). The topic 604 may include configuring a hardware component, a software component, or both. Each topic 604 may have one or more associated chapters, such as a chapter 606(1) to a chapter 606(R) (R>0). Each of the chapters 606 may have an associated hyperlink. For example, the chapter 606(1) may have an associated hyperlink 608(1) and the chapter 606(R) may have an associated hyperlink 608(R). As another example, the topic 604(S) may have one or more chapters 610 and one or more associated links 612. Selecting one of the links 608, 612 may cause the browser 108 to send a command to the server 104 to initiate playback of an associated segment of a training video. For example, in response to the user selecting link 608(1), the computing device 102 may send the command 138(1) to the server 104. In response to receiving the command 138(1) that indicates the selection of the link 608(1), the server 104 may identify a corresponding segment of the segments 128, such as the segment 128(1), and initiate streaming the segment 128(1) over the network 106 to the computing device 102. Selecting another of the links 608, 612 may cause the browser 108 to send a second command to the server 104 to initiate playback of another segment of a training video. For example, in response to the user selecting link 608(R), the computing device 102 may send the command 138(2) to the server 104. In response to receiving the command 138(2) that indicates the selection of the link 608(R), the server 104 may identify a corresponding segment of the segments 128, such as the segment 128(P), and initiate streaming the segment 128(P) over the network 106 to the computing device 102.

Each of the topics 604 may be displayed using one or more words describing the topic of the associated segment. The topic 604 may be automatically determined and labeled (using one or more words) by the machine learning 124 based on one or more of the NLP analysis 214, the text analysis 222, or the text analysis 238 of FIG. 2.

The support site 132 may include an area for a user to provide user comments 134. For example, the user comments 134 may enable the user to suggest a modified time 616 for a particular one of the links 608, 612. The user comments 134 may enable a user to suggest adding an additional chapter 618 to a particular topic 604. For example, the user may select the suggest modified time 616, select one of the links 608, 612, and input a suggested time where a segment may be modified to begin. The user may select suggest adding chapter 618, select one of the particular topics 604, and input a suggested time where a new segment may begin. The user comments 134 may be used by the machine learning 124 to modify one of the segmented videos 114 in the database 612 and used by the machine learning 124 to learn and fine-tune where to place chapter markers.

Thus, a user may browse a support site for a particular topic that is of interest to the user, such as modifying a hardware component or modifying a software component of a computing device. The user may browse the names of chapters corresponding to segments in a video and then select a hyperlink corresponding to a particular chapter. Selecting the hyperlink may cause the video to begin streaming, starting with a beginning of the selected segment, over a network.

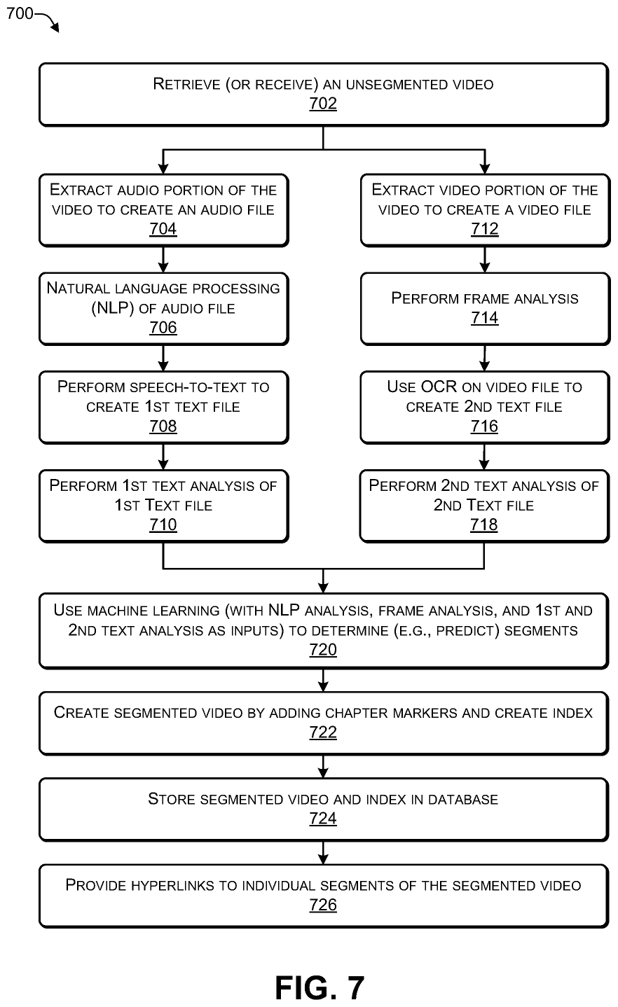

In the flow diagram of FIG. 7, each block represents one or more operations that can be implemented in hardware, software, or a combination thereof. In the context of software, the blocks represent computer-executable instructions that, when executed by one or more processors, cause the processors to perform the recited operations. Generally, computer-executable instructions include routines, programs, objects, modules, components, data structures, and the like that perform particular functions or implement particular abstract data types. The order in which the blocks are described is not intended to be construed as a limitation, and any number of the described operations can be combined in any order and/or in parallel to implement the processes. For discussion purposes, the process 700 is described with reference to FIGS. 1, 2, 3, 4, 5, and 6 as described above, although other models, frameworks, systems and environments may be used to implement this process.

FIG. 7 is a flowchart of a process 700 that uses machine learning to determine (e.g., identify) segments in a video, according to some embodiments. The process 700 may be performed by the server 104 as described herein.

At 702, the process may retrieve an unsegmented video. For example, in FIG. 1, the machine learning 124 may retrieve (or receive) the unsegmented video 116.

At 704, the process may extract an audio portion of the video to create an audio file. At 706, the process may perform natural language processing (NLP) of the audio file. At 708, the process may perform speech-to-text conversion to create a first text file. At 710, the process may perform a first text analysis of the first text file. For example, in FIG. 2, the audio analyzer 118 may use the audio extractor module 208 to extract the audio file 210 from the audio portions 202 of the unsegmented video 116. The audio analyzer 118 may use NLP 212 to analyze the audio file 210 to create the NLP analysis 214. The NLP 112 may identify particular words or phrases that are indicative of a beginning of a new segment, such as, for example, now, next, after, before, remove, insert, add, replace, and the like. The NLP 112 may perform a pitch analysis of a presenter's voice in the audio file 210. For example, the presenter's voice may change in pitch (e.g., higher or lower in pitch as compared to other portions of the video 116) when a particular segment is beginning or ending. The audio analyzer 118 may use the speech-to-text module 216 to convert speech included in the audio file 210 into text, thereby creating the first text file 218. The text analyzer module 220 may analyze the text file 218 to create the text analysis 222. For example, the text analyzer 220 may identify particular words or phrases that are indicative of a beginning of a new segment, such as, for example, next, after, before, remove, insert, add, replace, and the like. The audio analyzer 118 may provide the NLP analysis 214 and the text analysis 222 to the machine learning 124 to enable the machine learning 124 to determine when a segment begins, when a segment ends, or both.

At 712, the process may extract the video portion of the video to create a video file. At 714, the process may perform frame analysis. At 716, the process may use OCR on the video portion to create a second text file. At 718, the process may perform a second text analysis of the second text file. For example, in FIG. 2, the video analyzer 120 may use the video extractor 224 to extract the video portion 204 of the unsegmented video 116 to create the video file 226. The video analyzer 120 may use the frame analyzer 228 to analyze the frames in the video file 226 to create the frame analysis 230. The video analyzer 120 may use optical character recognition (OCR) 232 to recognize text displayed in one or more of the frames 206 to create the second text file 234. For example, the video file 226 may display text-based information in the video portions 204 of the video 116. The video analyzer 120 may use the text analyzer 236 to analyze the text file 234 to create the text analysis 238. The video analyzer 120 may provide the frame analysis 230 and the text analysis 238 to the machine learning 124 to enable the machine learning 124 to determine when a segment begins, when a segment ends, or both.

At 720, the process may use machine learning (with NLP analysis, frame analysis, and text analysis as inputs) to determine segments in the unsegmented video. For example, in FIG. 2, the machine learning 124 may use the NLP analysis 214, the first text analysis 222, the frame analysis 230, and the second text analysis 238 to identify segments in the unsegmented video 116 and place chapter markers at the beginning of each segment to create a segmented video. In some cases, the machine learning 124 may correlate the NLP analysis 214, the first text analysis 222, the frame analysis 230, and the second text analysis 238 to identify each segment.

At 722, the process may create a segmented video corresponding to the unsegmented video by adding chapter markers and creating an index associated with the segmented video. At 724, the segmented video and index may be stored in a database. At 726, hyperlinks to individual segments of the segmented video may be provided on a website to enable a user to access them. For example, in FIG. 1, the machine learning 124 may create the segmented video 126 corresponding to the unsegmented video 116 by adding chapter markers and creating an index associated with the segmented video 126. For example, in FIG. 6, the segmented video 126 and index 30 may be stored in the database 124. The links 608, 612 to individual segments 128 of the segmented video 126 may be provided on the support site 132.

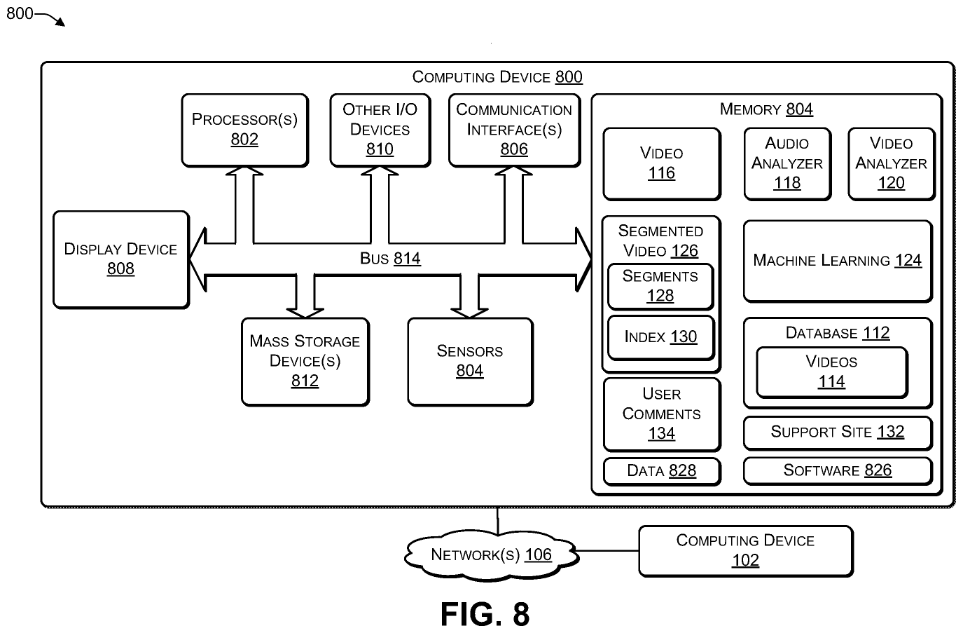

FIG. 8 illustrates an example configuration of a computing device 800 that can be used to implement the computing device 102 or the server 104 as described herein. For illustration purposes, the computing device 800 is shown in FIG. 8 implementing the server 104.

The computing device 102 may include one or more processors 802 (e.g., CPU, GPU, or the like), a memory 804, communication interfaces 806, a display device 808, the input devices 118, other input/output (I/O) devices 810 (e.g., trackball and the like), and one or more mass storage devices 812 (e.g., disk drive, solid state disk drive, or the like), configured to communicate with each other, such as via one or more system buses 814 or other suitable connections. While a single system bus 814 is illustrated for ease of understanding, it should be understood that the system buses 814 may include multiple buses, such as a memory device bus, a storage device bus (e.g., serial ATA (SATA) and the like), data buses (e.g., universal serial bus (USB) and the like), video signal buses (e.g., ThunderBolt®, DVI, HDMI, and the like), power buses, etc.

The processors 802 are one or more hardware devices that may include a single processing unit or a number of processing units, all of which may include single or multiple computing units or multiple cores. The processors 802 may include a graphics processing unit (GPU) that is integrated into the CPU or the GPU may be a separate processor device from the CPU. The processors 802 may be implemented as one or more microprocessors, microcomputers, microcontrollers, digital signal processors, central processing units, graphics processing units, state machines, logic circuitries, and/or any devices that manipulate signals based on operational instructions. Among other capabilities, the processors 802 may be configured to fetch and execute computer-readable instructions stored in the memory 804, mass storage devices 812, or other computer-readable media.

Memory 804 and mass storage devices 812 are examples of computer storage media (e.g., memory storage devices) for storing instructions that can be executed by the processors 802 to perform the various functions described herein. For example, memory 804 may include both volatile memory and non-volatile memory (e.g., RAM, ROM, or the like) devices. Further, mass storage devices 812 may include hard disk drives, solid-state drives, removable media, including external and removable drives, memory cards, flash memory, floppy disks, optical disks (e.g., CD, DVD), a storage array, a network attached storage, a storage area network, or the like. Both memory 804 and mass storage devices 812 may be collectively referred to as memory or computer storage media herein and may be any type of non-transitory media capable of storing computer-readable, processor-executable program instructions as computer program code that can be executed by the processors 802 as a particular machine configured for carrying out the operations and functions described in the implementations herein.

The computing device 800 may include one or more communication interfaces 806 for exchanging data via the network 106. The communication interfaces 806 can facilitate communications within a wide variety of networks and protocol types, including wired networks (e.g., Ethernet, DOCSIS, DSL, Fiber, USB etc.) and wireless networks (e.g., WLAN, GSM, CDMA, 802.11, Bluetooth, Wireless USB, ZigBee, cellular, satellite, etc.), the Internet and the like. Communication interfaces 806 can also provide communication with external storage, such as a storage array, network attached storage, storage area network, cloud storage, or the like.

The display device 808 may be used for displaying content (e.g., information and images) to users. Other I/O devices 810 may be devices that receive various inputs from a user and provide various outputs to the user, and may include a keyboard, a touchpad, a mouse, a printer, audio input/output devices, and so forth. The computer storage media, such as memory 116 and mass storage devices 812, may be used to store software and data, such as, for example, the machine learning 124, the segmented video 126, the database 112, the support site 132, other software 826, and other data 828.

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

Although the present invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims.

What is claimed is:

1. A method comprising:
retrieving, by one or more processors, a video;
extracting, by the one or more processors, an audio portion of the video to create an audio file;
extracting, by the one or more processors, a video portion of the video to create a video file;
analyzing, by the one or more processors, the audio file to create an audio analysis;
analyzing, by the one or more processors, the video file to create a video analysis;
determining, by a machine learning algorithm being executed by the one or more processors, one or segments in the video based on the audio analysis and the video analysis;
adding, by the one or more processors, one or more chapter markers to the video to create a segmented video, wherein individual chapter markers of the one or more chapter markers correspond to a starting position of individual segments of the one or more segments;
associating, by the one or more processors, a hyperlink of one or more hyperlinks with individual chapter markers of the one or more chapter markers;
creating, by the one or more processors, an index that includes the one or more hyperlinks; and
providing, by the one or more processors, access to the index via a network.

2. The method of claim 1, further comprising:
receiving from a computing device, via the network, a command selecting a particular hyperlink of the one or more hyperlinks;
determining a particular segment of the one or more segments corresponding to the particular hyperlink; and
initiating streaming the particular segment, via the network, to the computing device.

3. The method of claim 2, further comprising:
receiving from the computing device, via the network, a second command selecting a second particular hyperlink of the one or more hyperlinks;
determining a second particular segment of the one or more segments corresponding to the second particular hyperlink; and
initiating streaming of the second particular segment, via the network, to the computing device.

4. The method of claim 1, wherein analyzing the audio file to create the audio analysis comprises:
performing natural language processing to identify, in the audio file, a set of one or more words indicative of the start of a segment; and
indicating in the audio analysis, a time from a start of the video where the set of one or more words were spoken.

5. The method of claim 1, wherein analyzing the audio file to create the audio analysis comprises:
performing text-to-speech analysis of contents of the audio file to create a first text file;
performing natural language processing to identify, in the first text file, a set of one or more words indicative of the start of a segment; and
indicating in the audio analysis, a time from a start of the video where the set of one or more words are located.

6. The method of claim 1, wherein analyzing the video file to create the video analysis comprises:
performing, using a convolutional neural network, a frame analysis of the video file;
determining, using the frame analysis, a time of a start of at least one segment in the video file; and
indicating in the video analysis, the time of the start of at least one segment in the video file.

7. The method of claim 1, wherein analyzing the video file to create the video analysis comprises:
performing optical character recognition of one or more frames of the video to create a second text file;
performing natural language processing to identify, in the second text file, a set of one or more words indicative of the start of a segment; and
indicating in the video analysis, a time from a start of the video where the set of one or more words are located.

8. A server comprising:
one or more processors; and
one or more non-transitory computer-readable storage media to store instructions executable by the one or more processors to perform operations comprising:
retrieving a video;
extracting an audio portion of the video to create an audio file;
extracting a video portion of the video to create a video file;
analyzing the audio file to create an audio analysis;
analyzing the video file to create a video analysis;
determining, by a machine learning algorithm, one or segments in the video based on the audio analysis and the video analysis;
adding one or more chapter markers to the video to create a segmented video, wherein individual chapter markers of the one or more chapter markers correspond to a starting position of individual segments of the one or more segments;
associating a hyperlink of one or more hyperlinks with individual chapter markers of the one or more chapter markers;
creating an index that includes the one or more hyperlinks; and
providing access to the index via a network.

9. The server of claim 8, wherein the operations further comprise:
receiving from a computing device, via the network, a command selecting a particular hyperlink of the one or more hyperlinks;
determining a particular segment of the one or more segments corresponding to the particular hyperlink; and
initiating streaming the particular segment, via the network, to the computing device.

10. The server of claim 8, wherein analyzing the audio file to create the audio analysis comprises:
performing natural language processing to identify, in the audio file, a set of one or more words indicative of the start of a segment; and
indicating in the audio analysis, a time from a start of the video where the set of one or more words were spoken.

11. The server of claim 8, wherein analyzing the audio file to create the audio analysis comprises:
performing text-to-speech analysis of contents of the audio file to create a first text file;
performing natural language processing to identify, in the first text file, a set of one or more words indicative of the start of a segment; and
indicating in the audio analysis, a time from a start of the video where the set of one or more words are located.

12. The server of claim 8, wherein analyzing the video file to create the video analysis comprises:
determining using a micro-expression analyzer one or more micro-expressions of a presenter in the video;
determining a sentiment corresponding to the micro-expression; wherein the sentiment comprises one of happy or unhappy; and
indicating in the video analysis, a time of a start of the micro-expression and the corresponding sentiment.

13. The server of claim 8, wherein analyzing the video file to create the video analysis comprises:
performing, using a convolutional neural network, a frame analysis of the video file;
determining, using the frame analysis, a time of a start of at least one segment in the video file; and
indicating in the video analysis, the time of the start of at least one segment in the video file.

14. The server of claim 8, wherein analyzing the video file to create the video analysis comprises:
performing optical character recognition of one or more frames of the video to create a second text file;
performing natural language processing to identify, in the second text file, a set of one or more words indicative of the start of a segment; and
indicating in the video analysis, a time from a start of the video where the set of one or more words are located.

15. One or more non-transitory computer readable media storing instructions executable by one or more processors to perform operations comprising:
retrieving a video;
extracting an audio portion of the video to create an audio file;
extracting a video portion of the video to create a video file;
analyzing the audio file to create an audio analysis;
analyzing the video file to create a video analysis;
determining, by a machine learning algorithm, one or segments in the video based on the audio analysis and the video analysis;
adding one or more chapter markers to the video to create a segmented video, wherein individual chapter markers of the one or more chapter markers correspond to a starting position of individual segments of the one or more segments;
associating a hyperlink of one or more hyperlinks with individual chapter markers of the one or more chapter markers;
creating an index that includes the one or more hyperlinks; and
providing access to the index via a network.

16. The one or more non-transitory computer readable media of claim 15, further comprising:
receiving from a computing device, via the network, a command selecting a particular hyperlink of the one or more hyperlinks;
determining a particular segment of the one or more segments corresponding to the particular hyperlink; and
initiating streaming the particular segment, via the network, to the computing device.

17. The one or more non-transitory computer readable media of claim 15, wherein analyzing the audio file to create the audio analysis comprises:
performing natural language processing to identify, in the audio file, a set of one or more words indicative of the start of a segment; and
indicating in the audio analysis, a time from a start of the video where the set of one or more words were spoken.

18. The one or more non-transitory computer readable media of claim 15, wherein analyzing the audio file to create the audio analysis comprises:
performing text-to-speech analysis of contents of the audio file to create a first text file;
performing natural language processing to identify, in the first text file, a set of one or more words indicative of the start of a segment; and
indicating in the audio analysis, a time from a start of the video where the set of one or more words are located.

19. The one or more non-transitory computer readable media of claim 15, wherein analyzing the video file to create the video analysis comprises:
performing, using a convolutional neural network, a frame analysis of the video file;
determining, using the frame analysis, a time of a start of at least one segment in the video file; and
indicating in the video analysis, the time of the start of at least one segment in the video file.

20. The one or more non-transitory computer readable media of claim 15, wherein analyzing the video file to create the video analysis comprises:
performing optical character recognition of one or more frames of the video to create a second text file;
performing natural language processing to identify, in the second text file, a set of one or more words indicative of the start of a segment; and
indicating in the video analysis, a time from a start of the video where the set of one or more words are located.
